(19) United States
(12) Patent Application Publication
(10) Pub. No.: US 2024/0140521 A1
(43) Pub. Date: May 2, 2024

(54) SYSTEM AND METHOD FOR FAIL-SAFE OPERATION FOR ANGLE SENSORS IN STEER-BY-WIRE SYSTEM

(71) Applicant: HL MANDO CORPORATION, Gyeonggi-do (KR)

(72) Inventor: Kyuyeong JE, Gyeonggi-do (KR)

(21) Appl. No.: 18/138,036

(22) Filed: Apr. 22, 2023

(30) Foreign Application Priority Data
Oct. 26, 2022 (KR) 10-2022-0139258

(51) Int. Cl. B62D 5/00; B62D 15/02; G01B 21/22

(52) U.S. Cl. CPC B62D 5/003; B62D 15/0215; B62D 15/0235; G01B 21/22

(57) ABSTRACT

A fail-safe structure for angle sensors in a Steer-by-Wire (SbW) system may include first and second angle sensors configured to sense a steering angle of a steering wheel associated with a steering feedback actuator assembly, a first MCU configured to receive a first angle signal from the first angle sensor, a second MCU configured to receive a second angle signal from the second angle sensor, and a motor position sensor configured to sense a position of a motor associated with the steering feedback actuator assembly. The first MCU may be configured to, if the first angle signal and the second angle signal do not match each other, receive a motor position signal associated with the position of the motor from the motor position sensor to determine the steering angle of the steering wheel.

### CROSS-REFERENCE TO RELATED APPLICATION

This application claims priority under 35 U.S.C. § 119 to Korean Patent Application No. 10-2022-0139258, filed on Oct. 26, 2022, in the Korean Intellectual Property Office (KIPO), the disclosure of which is incorporated by reference herein in its entirety.

### TECHNICAL FIELD

The present disclosure generally relates to a system and method for a fail-safe operation for angle sensors in a Steer-by-Wire (SbW) system, and more particularly, to a system and method for performing a fail-safe operation for angle sensors using one or more motor position sensors in the SbW system.

### BACKGROUND

A Steer-by-Wire (SbW) system comprises a steering feedback actuator (SFA) included in a steering wheel module and a road wheel actuator (RWA) included in a vehicle wheel module. The SFA assembly and the RWA assembly are connected by an electric wire, and when a driver turns a steering wheel, an electrical signal is transmitted from the SFA assembly to the RWA assembly to facilitate the steering of the vehicle. For example, if an angle signal representing the steering angle of the steering wheel is synchronized with an angle signal representing the angle of the vehicle wheels, the steering of the vehicle can be appropriately performed.

Meanwhile, if the angle signals are not synchronized due to a failure occurring in any one of angle sensors that senses the angle of the steering wheel or the vehicle wheels, the steering of the vehicle may not be normally performed. For example, when a failure occurs in any one of sensors comprised in the SFA assembly and/or the RWA assembly, the angle signals may not be synchronized, and it may be difficult to find which sensor has failed.

To solve this problem, a separate angle sensor may be added, but this may be costly and time-consuming for developing the additional angle sensor. And, a steering angle initialization setting logic, which involves repeatedly moving the steering wheel or the vehicle wheels from the left end to the right end two to three times when the vehicle is started, can be used. However, it may be troublesome to repeatedly perform such an operation every time the vehicle is started.

### SUMMARY

To solve the above-mentioned problems, the present disclosure provides a system and method for a fail-safe operation for angle sensors in an SbW system, a computer program stored on a non-transitory computer-readable medium storing instructions, and a computer-readable medium and apparatus (or system) storing the computer program.

The present disclosure may be implemented in various ways, including a non-transitory computer-readable medium storing a structure, method, apparatus (system), or computer program.

According to an embodiment of the present disclosure, a fail-safe structure for angle sensors in an SbW system may include: a first angle sensor and a second angle sensor that sense a steering angle of a steering wheel associated with an SFA system; a first MCU that receives a first angle signal from the first angle sensor; a second MCU that receives a second angle signal from the second angle sensor; and a first motor position sensor that senses a position of a motor associated with the SFA system. If the first angle signal and the second angle signal do not match, the first MCU may receive the second angle signal from the second MCU and a first motor position signal associated with the position of the motor from the first motor position sensor to determine the steering angle of the steering wheel.

According to an embodiment of the present disclosure, the first MCU may compare the first angle signal, the second angle signal, and the first motor position signal to determine two matching signals as normal signals corresponding to the steering angle of the steering wheel.

According to an embodiment of the present disclosure, the first motor position sensor may have an initial median value of the steering wheel.

According to an embodiment of the present disclosure, the first motor position sensor may generate a first motor position signal associated with the steering angle of the steering wheel angle based on the initial median value of the steering wheel and the sensed position of the motor.

According to an embodiment of the present disclosure, the first motor position sensor may be separated from an IGN signal and connected to a battery power.

According to an embodiment of the present disclosure, the fail-safe structure may further include a regulator for converting a battery voltage into a specific voltage. The regulator may be connected between the battery power and the first motor position sensor to convert the battery voltage from the battery power into a specific voltage and provide the converted voltage to the first motor position sensor.

According to an embodiment of the present disclosure, the first motor position sensor may maintain an ON state when the vehicle ignition is in either an ON or OFF state.

According to an embodiment of the present disclosure, the fail-safe structure may further include a second motor position sensor that senses a position of a motor associated with the SFA system. The second MCU may receive the first angle signal from the first MCU and a second motor position signal associated with the position of the motor from the second motor position sensor to determine the steering angle of the steering wheel.

According to an embodiment of the present disclosure, the second MCU may compare the first angle signal, the second angle signal, and the second motor position signal to determine two matching signals as normal signals corresponding to the steering angle of the steering wheel.

According to an embodiment of the present disclosure, the second motor position sensor may have an initial median value of the steering wheel.

According to an embodiment of the present disclosure, the second motor position sensor may generate a second motor position signal associated with the steering angle of the steering wheel based on the initial median value of the steering wheel and the sensed position of the motor.

According to an embodiment of the present disclosure, the second motor position sensor may be separated from the IGN signal and connected to the battery power.

According to an embodiment of the present disclosure, the fail-safe structure may further include a regulator for converting the battery voltage into a specific voltage. The regulator may be connected between the battery power and the second motor position sensor to convert the battery voltage from the battery power into a specific voltage and provide the converted voltage to the second motor position sensor.

According to an embodiment of the present disclosure, the second motor position sensor may remain in an ON state when the vehicle ignition is in either an ON or OFF state.

According to an embodiment of the present disclosure, a control structure for an SbW system may include: at least one motor position sensor that is separated from an IGN signal and connected to a battery power; at least one MCU that is connected to the IGN signal and the battery power; and a first regulator that converts a battery voltage into a specific voltage and provides the converted voltage to the at least one MCU.

According to an embodiment of the present disclosure, the at least one motor position sensor may have an initial median value of a steering wheel.

According to an embodiment of the present disclosure, the at least one motor position sensor may generate a motor position signal associated with a steering angle of the steering wheel based on the initial median value of the steering wheel and a sensed position of a motor.

According to an embodiment of the present disclosure, the control structure for an SbW system may further include a second regulator that converts the battery voltage into a specific voltage and provides the converted voltage to the at least one motor position sensor.

According to an embodiment of the present disclosure, the at least one MCU may determine the steering angle of the steering wheel based on a first angle signal obtained from a first angle sensor, a second angle signal obtained from a second angle sensor, and a motor position signal obtained from the at least one motor position sensor.

According to an embodiment of the present disclosure, the at least one MCU may compare the first angle signal, the second angle signal, and a second motor position signal to determine two matching signals as normal signals corresponding to the steering angle of the steering wheel.

According to an embodiment of the present disclosure, a fail-safe method for angle sensors in an SbW system performed by at least one processor may include: sensing, at a first angle sensor and a second angle sensor, a steering angle of a steering wheel associated with an SFA system; providing, at the first angel sensor, a first angle signal to a first MCU; providing, at the second angel sensor, a second angle signal to a second MCU; sensing, at a first motor position sensor, a position of a motor associated with the SFA system; and if the first angle signal and the second angle signal do not match, receiving, at the first MCU, the second angle signal from the second MCU and a first motor position signal associated with the position of the motor from the first motor position sensor to determine the steering angle of the steering wheel.

According to an embodiment of the present disclosure, a fail-safe structure for angle sensors in an SbW system may include: third and fourth angle sensors configured to sense a steering angle of vehicle wheels associated with an RWA system; a third MCU configured to receive a third angle signal corresponding to the steering angle of the vehicle wheels sensed by the third angle sensor; a fourth MCU that receives a fourth angle signal corresponding to the steering angle of the vehicle wheels sensed by the fourth angle sensor; and a third motor position sensor configured to sense a position of a motor associated with the RWA system. If the third angle signal and the fourth angle signal do not match with each other, the third MCU may receive the fourth angle signal from the fourth MCU and a third motor position signal associated with the position of the motor sensed by the third motor position sensor to determine the steering angle of the vehicle wheels.

In various embodiments of the present disclosure, the first MCU may determine whether a failure has occurred in either the first angle sensor or the second angle sensor by further receiving an additional signal from the first motor position signal, and may perform the steering control of the vehicle based on a signal of an angle sensor that has not failed.

In various embodiments of the present disclosure, even when the steering angle initialization setting logic is performed or an additional angle sensor is not provided, a system and method for the fail-safe operation for the angle sensors can operate efficiently using the existing motor position sensors.

In certain embodiments of the present disclosure, instead of using a single regulator, an additional regulator that is separated from, or is not connected to, a line or terminal for an ignition signal and is directly connected to a battery power may be provided so that the motor position sensor can operate stably even when the voltage range of the battery power is high.

The effects of the present disclosure are not limited to those mentioned above, and other effects not mentioned will be clearly understood by those skilled in the art to which the present disclosure pertains from the description of the appended claims.

### BRIEF DESCRIPTION OF THE DRAWINGS

The embodiments of the present disclosure will be described with reference to the accompanying drawings described below, in which like reference numerals denote like elements, but are not limited thereto.

FIG. 1 is a diagram showing a Steer-by-Wire (SbW) system comprising a steering feedback actuator (SFA) assembly and a road wheel actuator (RWA) assembly according to an embodiment of the present disclosure.

FIG. 2 is a block diagram showing a first micro control unit (MCU) and a second MCU comparing angle signals with each other.

FIG. 3 is a diagram showing a system for performing a fail-safe operation for angle sensors using a motor position sensor according to an embodiment of the present disclosure.

FIG. 4 is a diagram showing a system for performing a fail-safe operation for angle sensors using a first motor position sensor and a second motor position sensor according to an embodiment of the present disclosure.

FIG. 5 is a block diagram showing a power connection structure between a first motor position sensor and a first MCU.

FIG. 6 is a block diagram showing a power connection structure between a first motor position sensor and a first MCU according to an embodiment of the present disclosure.

FIG. 7 is a block diagram showing a power connection structure in which an additional regulator is connected between a battery power and a motor position sensor according to an embodiment of the present disclosure.

FIG. 8 is a flowchart showing a fail-safe method for angle sensors in an SbW system according to an embodiment of the present disclosure.

### DETAILED DESCRIPTION

Hereinafter, specific details for implementing the present disclosure will be described in detail with reference to the accompanying drawings. In the following description, if detailed descriptions of well-known functions or configurations would unnecessarily obscure the gist of the present disclosure, the detailed descriptions will be omitted.

In the accompanying drawing, the same or corresponding components are given the same reference numerals. Moreover, in the following description of the embodiments, a detailed description of the same or corresponding components may be omitted. However, even when the description of the components is omitted, it is not intended that such components are not included in any embodiment.

Advantages and features of the present disclosure, and methods for achieving them, will become apparent with reference to the following embodiments in conjunction with the accompanying drawings. However, the present disclosure is not limited to the embodiments disclosed below and may be implemented in various different forms. The embodiments are provided only to complete the present disclosure and to allow those skilled in the art to which the present disclosure pertains to fully understand the scope of the present disclosure.

The terms used herein will be briefly described, and the disclosed embodiments will be described in detail. The terms used herein are general terms selected as those that are now used as widely as possible in consideration of the functions of the present disclosure, but they may vary depending on the intention of those skilled in the art or the precedents or the emergence of new technology. Moreover, in certain cases, there may be terms arbitrarily selected by the applicant, and in this case, the meaning will be described in the corresponding description part of the specification. Accordingly, it should be noted that the terms used herein should be interpreted based on the substantial meaning of the terms and the context throughout the specification, rather than simply the name of the terms.

In the present disclosure, the singular forms are intended to include the plural forms as well, unless the context clearly indicates otherwise. Moreover, the plural forms are intended to include the singular forms as well, unless the context clearly indicates otherwise. When it is said that a certain part includes a certain component throughout entire specification, it means that it may further include other components without excluding other components unless otherwise stated.

In the present disclosure, the terms such as “comprising,” “including,” or the like may indicate the existence of characteristics, steps, operations, elements, and/or components, but such terms do not exclude the presence of one or more other functions, steps, operations, elements, components, and/or combinations thereof.

In the present disclosure, if a specific component is mentioned as being “coupled,” “combined,” “connected,” or “reacted” with any other component, it means that the specific component can be directly coupled, combined, connected, or reacted with the other component(s), but is not limited thereto. For example, one or more intermediate components may exist between one component and another component. In addition, in the present disclosure, the term “and/or” may include each of one or more items listed or a combination of at least some of one or more items.

In the present disclosure, the terms such as “first,” “second,” or the like are used to distinguish a specific component from other components, and the described components are not limited by these terms. For example, a “first” component may have the same or similar shape as a “second” component.

The term “Steer-by-Wire (SbW) system” may refer to an electrical signal-controlled intelligent steering system configured to transmit electrical signals representing, or associated with, the driver's steering intention to an electronic control system or an electronic control unit (ECU) without any mechanical connection between the steering wheel and the vehicle wheels. According to an embodiment, the SbW system may include a steering feedback actuator (SFA) assembly and a road wheel actuator (RWA) assembly, and the SFA assembly and the RWA assembly may be connected by a wire which can carry electrical signals. The SFA assembly may be an actuator system configured to generate steering control information associated with the steering angle based on the degree of rotation of the steering wheel of the vehicle, user input or operation, etc., and to provide the user with a counter-force to the steering wheel, and the RWA system may be a system configured to move wheels of the vehicle based on the steering control information. The SbW system can control the movement of the wheels of the vehicle based on the steering control information.

In the present disclosure, the “micro control unit (MCU)” is a module associated with the SFA assembly and/or the RWA assembly and may refer to a module for generating, processing, and/or managing any electrical signal for controlling a vehicle.

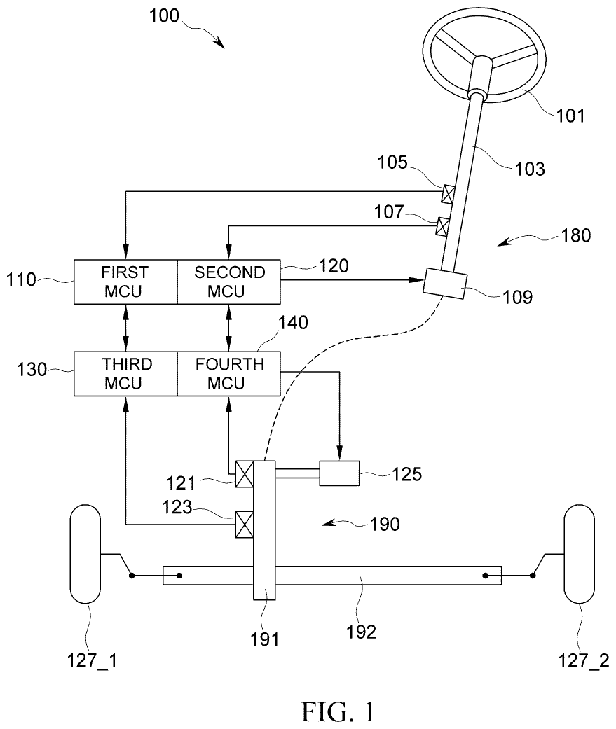

FIG. 1 is a diagram showing an SbW assembly 100 comprising an SFA system and an RWA system according to an embodiment of the present disclosure. According to an embodiment of the present disclosure, the SbW assembly 100 may include an SFA assembly 180 associated with a steering wheel 101 and an RWA assembly 190 associated with vehicle wheels 127.

As shown in FIG. 1, the SbW assembly 100 may include a first angle sensor 105 and a second angle sensor 107 provided on or around a steering shaft 103 connected to the steering wheel 101. Various sensors such as the first angle sensor 105 and the second angle sensor 107 associated with the SFA assembly 180 may sense the operation or manipulation of the steering wheel 101 indicating the driver's steering intention and transmit electrical signals to a first MCU 110 and a second MCU 120. For example, a first angle signal generated by the first angle sensor 105 may be provided to the first MCU 110, and a second angle signal generated by the second angle sensor 107 may be provided to the second MCU 120. In this case, the first MCU 110 and/or the second MCU 120 may drive a motor 109 based on the received electrical signal(s) such as the first angle signal and the second angle signal.

According to an embodiment of the present disclosure, the first MCU 110 and/or the second MCU 120 may control the motor 109 of the SFA assembly 180 based on the electrical signals received from the first angle sensor 105 and the second angle sensor 107 as well as various other sensors mounted on the vehicle. For example, the first MCU 110 and/or the second MCU 120 may receive steering information from various sensors such as motor position sensors, radar, lidar, camera image sensors, etc. Here, when the driver manipulates the steering wheel 101, the motor 109 of the SFA assembly 180 can apply a reaction torque or counter-torque in a direction opposite to the driver's steering torque to the steering shaft 101 to provide or increase the steering feel to the driver, or can turn the steering shaft 103 during autonomous driving to assist the steering of the vehicle.

According to an embodiment of the present disclosure, a third angle sensor 121 and a fourth angle sensor 123 associated with the RWA assembly 190 may measure a rotation angle of a pinion gear 191, a linear position of a rack bar 192, or any position associated with the vehicle wheels 127. The rotation angle measured by the third angle sensor 121 and the fourth angle sensor 123 may be converted into a linear displacement of the axis, transmitted as feedback information to a third MCU 130 and a fourth MCU 140, and used for precise control of the vehicle wheels 127. For example, a third angle signal generated by the third angle sensor 121 may be provided to the third MCU 130, and a fourth angle signal generated by the fourth angle sensor 123 may be provided to the fourth MCU 140. That is, the third MCU 130 and/or the fourth MCU 140 may control a motor 125 of the RWA assembly 190 based on electrical signals received from various sensors including the third angle sensor 121 and the fourth angle sensor 123, thereby facilitating the controlling and steering of the vehicle wheels 127.

According to an embodiment of the present disclosure, in order to reflect the driver's steering intention, it may be determined whether the angle signals associated with the steering wheel 101 and/or the vehicle wheels 127 match each other. To this end, if the electrical signal (e.g., the first angle signal) of the first angle sensor 105 and the electrical signal (e.g., the second angle signal) of the second angle sensor 107 match each other, the first MCU 110 and/or the second MCU 120 may perform the steering control of the vehicle. If the electrical signal (e.g., the third angle signal) of the third angle sensor 121 and the electrical signal (e.g., the fourth angle signal) of the fourth angle sensor 123 match each other, the third MCU 130 and/or the fourth MCU 140 may perform the steering control of the vehicle.

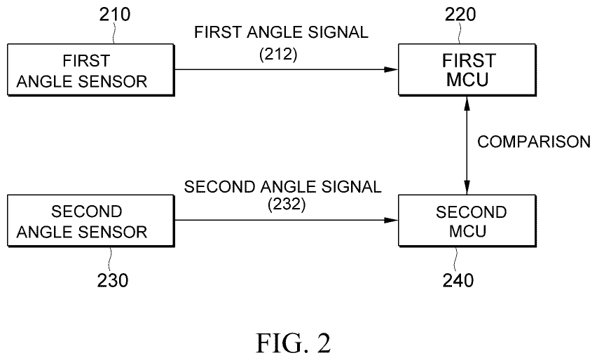

FIG. 2 is a block diagram showing a first MCU 220 and a second MCU 240 comparing a first angle signal 212 and a second angle signal 232 with each other. As described above, in order to perform the steering control, the first MCU 220 and the second MCU 240 may receive the first angle signal 212 and the second angle signal 232 from a first angle sensor 210 and a second angle sensor 230, respectively, and compare the first angle signal 212 and the second angle signal 232 with each other. That is, the first MCU 220 and the second MCU 240 may receive the first angle signal 212 and the second angle signal 232, respectively, each indicating the angle of the steering wheel 101 to determine whether a failure has occurred in sensing the steering angle of the steering wheel 101 through the comparison of the angle signals.

When the failure occurs in either the first angle sensor 210 or the second angle sensor 230, a fail-safe operation for performing the steering control of the vehicle even in the event of the failure may be required. In other words, as a result of the comparison of the first angle signal 212 of the first MCU 220 and the second angle signal 232 of the second MCU 240, if the first angle signal 212 and the second angle signal 232 are not synchronized or are not substantially equal to each other, it may be determined that a failure has occurred in either the first angle sensor 210 or the second angle sensor 230.

Conventionally, for the fail-safe operation, angle sensors were calibrated through a steering angle initialization setting logic during the initial startup of the SFA assembly 180 and the RWA assembly 190. For example, when a failure occurred in the first angle sensor 210 and/or the second angle sensor 230 associated with the SFA assembly 180, the angle sensors 210 and/or 230 were calibrated by repeatedly moving the steering wheel 101 from the left end to the right end multiple times such as two to three times. When a failure occurred in the third angle sensor 121 and/or the fourth angle sensor 123 associated with the RWA assembly 190, the angle sensors were 121 and/or 123 calibrated by repeatedly moving the vehicle wheels 127 from the left end to the right end multiple times such as two to three times. However, such a steering angle initialization setting logic is repeatedly driven whenever the vehicle is restarted, and this initialization takes time for executing the logic and lowers the marketability of the vehicle.

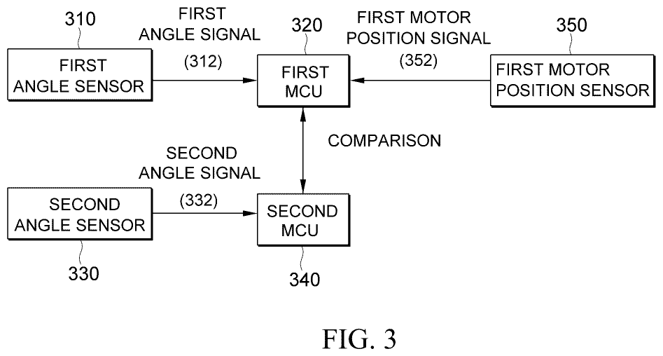

FIG. 3 is a diagram showing a system for a fail-safe operation for angle sensors using a first motor position sensor 350 of the SFA assembly 180 according to an embodiment of the present disclosure. According to an embodiment of the present disclosure, the first motor position sensor 350 may be a sensor for sensing a motor position associated with the SFA assembly 180. For example, the first motor position sensor 350 may be a sensor for determining a relative position of a motor 109 that controls the steering of the steering wheel 101 or provide torque to the steering wheel 101.

According to an embodiment of the present disclosure, the first motor position sensor 350 may calculate a steering angle of the steering wheel 101 using the relative position of the motor 109 of the SFA assembly 180 and an initial median value of the steering wheel 101. Accordingly, the first motor position sensor 350 can calculate the steering angle of the steering wheel 101 without receiving a signal from any angle sensor, for example, the first angle sensor 310 and the second angle sensor 330. The first motor position sensor 350 may transmit a first motor position signal 352 including information about the calculated steering angle of the steering wheel 101 to a first MCU 320.

As described above, the first MCU 320 may receive a first angle signal 312 associated with the steering angle of the steering wheel 101 sensed by a first angle sensor 310 from the first angle sensor 310, and a second MCU 340 may receive a second angle signal 332 associated with the steering angle of the steering wheel 101 sensed by a second angle sensor 330 from the second angle sensor 330. According to an embodiment of the present disclosure, the first MCU 320 may receive the second angle signal 332 from the second MCU 340 and the first motor position signal 352 associated with the position of the motor 109 of the SFA assembly 180 from the first motor position sensor 350 to determine the steering angle of the steering wheel 101. For example, the first MCU 320 may compare the first angle signal 312, the second angle signal 332, and the first motor position signal 352, and determine at least two signals matching each other as normal signals corresponding to the steering angle of the steering wheel 101.

With this configuration, the first MCU 320 may further receive a signal from the first motor position signal 352 to determine whether a failure has occurred in either the first angle sensor 310 or the second angle sensor 330, thereby performing the steering control of the vehicle based on a signal of an angle sensor in which no failure has occurred.

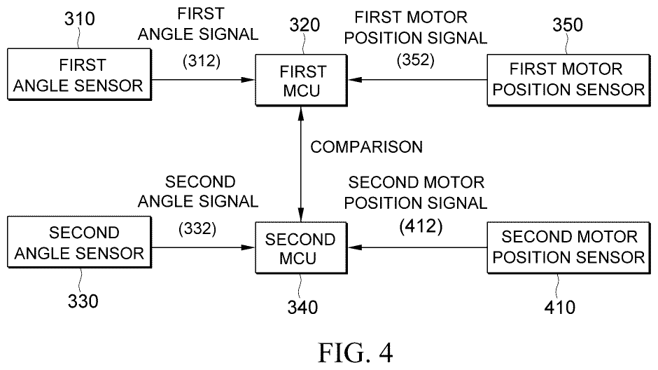

FIG. 4 is a diagram showing a system for a fail-safe operation for angle sensors using the first motor position sensor 350 and a second motor position sensor 410 according to an embodiment of the present disclosure. According to an embodiment of the present disclosure, the second motor position sensor 410 may be a sensor for sensing a motor position of the motor 109 associated with the SFA assembly 180.

According to an embodiment of the present disclosure, the second motor position sensor 410 may calculate a steering angle of the steering wheel 101 using a relative position of the motor 109 of the SFA assembly 180 and an initial median value of the vehicle wheels 127. Therefore, the second motor position sensor 410 can calculate the steering angle of the steering wheel 101 without receiving a signal from any angle sensor such as the first angle sensor 310 and the second angle sensor 330. The second motor position sensor 410 may transmit a second motor position signal 412 including information about the calculated steering angle of the steering wheel 101 to the second MCU 340.

As described above, the first MCU 320 may receive the first angle signal 312 associated with the steering angle of the steering wheel 101 sensed by a first angle sensor 310 from the first angle sensor 310. Also, the first MCU 320 may receive the first motor position signal 352 from the first motor position sensor 350. According to an embodiment of the present disclosure, the second MCU 340 may receive the first angle signal 312 from the first MCU 320 and the second motor position signal 412 associated with the position of the motor 109 of the SFA assembly 180 from the second motor position sensor 410 to determine the steering angle of the vehicle wheels 127. For example, the second MCU 340 may compare the first angle signal 312, the second angle signal 332, and the second motor position signal 412 to determine at least two signals matching each other as normal signals corresponding to the steering angle of the steering wheel 101 or vehicle wheels 127.

Additionally or alternatively, the second MCU 340 may receive the first motor position signal 352 from the first MCU 320 and compare the first angle signal 312, the second angle signal 332, the first motor position signal 352, and the second motor position signal 412 to determine at least two signals matching each other as normal signals corresponding to the steering angle of the steering wheel 101 or vehicle wheels 127.

Although the fail-safe operation system according to the embodiment shown in FIG. 4 include both the first motor position sensor 350 and the second motor position sensor 410, it is not limited thereto, and, for instance, only one of the two sensors may be included. Moreover, although the process of performing the fail-safe operation for the angle sensors in the SFA assembly 180 has been described with reference to FIG. 4, it is not limited thereto, and a process of performing the fail-safe operation for angle sensors in the RWA assembly 190 may also be performed in the same manner as described above. With this configuration, even when the steering angle initialization setting logic is performed or an additional angle sensor that incurs additional cost is not provided, the fail-safe operation system for the angle sensors can operate efficiently using the existing motor position sensors.

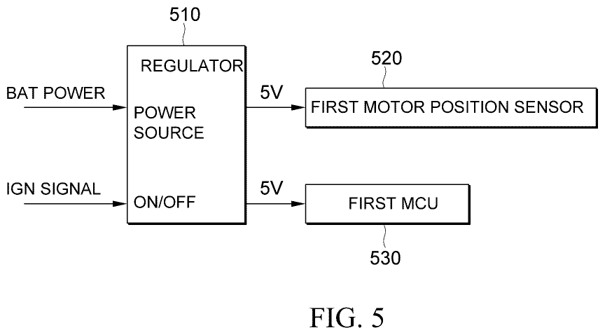

FIG. 5 is a block diagram showing a power connection structure between a first motor position sensor 520 and a first MCU 530. In a conventional power connection structure, the first motor position sensor 520 and the first MCU 530 are connected to a battery power (BAT power) and a line or terminal for an ignition signal (an IGN signal) via a regulator 510. Here, the IGN signal may be a signal associated with a vehicle ignition ON or OFF state.

As shown in FIG. 5, the regulator 510 may be configured to convert the battery voltage into a specific voltage. The regulator 510 may be connected to the BAT power and the line or terminal for the IGN signal, and may also be connected to the first motor position sensor 520 and the first MCU 530. Since the first motor position sensor 520 is connected to the regulator 510 connected to the BAT power and the line or terminal for the IGN signal in the embodiment of FIG. 5, the first motor position sensor 520 can remain in an ON state only when the vehicle is turned ON, and when the vehicle is turned OFF, the state of the first motor position sensor 520 may also be switched to an OFF state.

In the embodiment of FIG. 5, when the first motor position sensor 520 is turned ON or OFF according to the vehicle ignition state, the first motor position sensor 520 may not have a factory-set initial median value of the steering wheel 101. In this case, the first motor position sensor 520 has no choice but to receive information on the steering angle of the steering wheel 101 from at least one of angle sensors and thus cannot be used in a system for the fail-safe operation for the angle sensors.

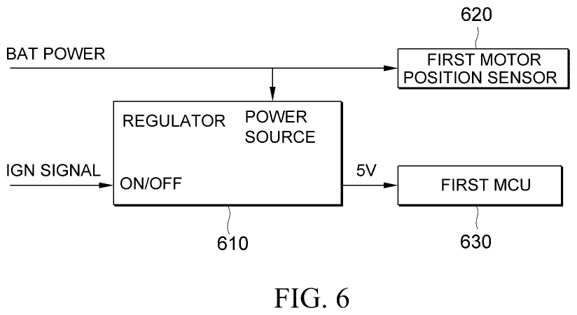

FIG. 6 is a block diagram showing a power connection structure between a first motor position sensor 620 and a first MCU 630 according to an embodiment of the present disclosure. As shown in FIG. 6, a BAT power may be provided to a regulator 610 and the first motor position sensor 620, and an IGN signal may be provided to the regulator 610. The first MCU 630 connected to the regulator 610 may be turned ON when the vehicle ignition is in an ON state and turned off when the vehicle ignition is in an OFF state according to the IGN signal.

According to an embodiment of the present disclosure, the first motor position sensor 620 may be directly connected to the BAT power and thus can be connected to a power source at all times regardless of the IGN signal or the vehicle ignition state. That is, the first motor position sensor 620 may not be affected by the operation of the regulator 610 that receives the IGN signal, and thus the first motor position sensor 620 can always remain in an ON state even when the vehicle is turned OFF. As such, because the power source is always connected to the first motor position sensor 620, the first motor position sensor 620 may have a factory-set initial median value of the steering wheel 101 regardless of the vehicle ignition state. With this configuration, the first motor position sensor 620 may determine or calculate the steering angle of the steering wheel 101 without receiving a signal from an angle sensor, such as the first angle sensor 105 and/or the second angle sensor 107, using the initial median value and the position value of the motor 109 of the SFA assembly 180.

Although the first motor position sensor 620 is shown to be directly connected to the BAT power in FIG. 6, it is not limited thereto. For example, the first motor position sensor 620 may be indirectly connected to the BAT power through any connection means or other elements. And, the second motor position sensor 123 or 410 associated with the RWA assembly 190 may also be connected directly to the BAT power. In this case, the second motor position sensor 123 or 410 may always remain in an ON state even when the vehicle ignition is in either an ON or OFF state and may have an initial median value of the vehicle wheels 127.

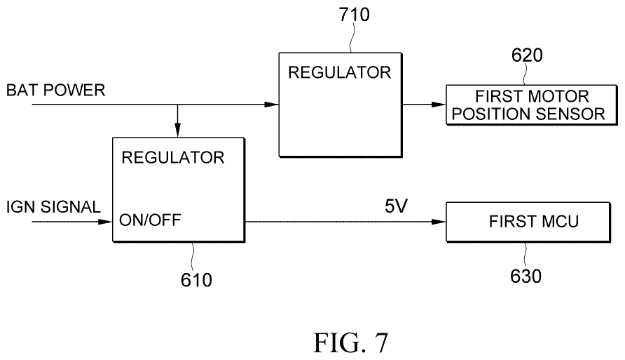

FIG. 7 is a block diagram showing a power connection structure in which another regulator 710 is connected between a BAT power and a first motor position sensor 620 according to an embodiment of the present disclosure. According to an embodiment of the present disclosure, another regulator 710 not directly connected to a line or terminal for the IGN signal may be connected between the BAT power and the first motor position sensor 620. Even with this configuration, as described above with reference to FIG. 6, the first motor position sensor 620 may not be affected by the IGN signal and thus the first motor position sensor 620 can always remain in an ON state even when the vehicle ignition is in not only an ON state but also an OFF state. Therefore, the first motor position sensor 620 may continue to have the initial median value of the steering wheel 101 regardless of the vehicle ignition state.

According to an embodiment of the present disclosure, the BAT voltage range may be higher than the rated internal pressure range of the first motor position sensor 620. In this case, the other regulator 710 not connected to the line or terminal for the IGN signal or configured to be operable regardless of the IGN signal is located between the first motor position sensor 620 and the BAT power to convert the battery voltage into a specific voltage appropriate for the first motor position sensor 620, and provide the converted voltage to the first motor position sensor 620. In this case, the other regulator 710 may be also directly connected to the BAT power and thus can operate at all times even when the vehicle ignition is turned OFF.

Although the other regulator 710 is shown to be located between the first motor position sensor 620 and the BAT power in FIG. 7, it is not limited thereto. For example, a special regulator not directly connected with the line or terminal for the IGN signal or configured to be operable regardless of the IGN signal may be provided between the third motor position sensor 121 and/or the fourth motor position sensor 123 associated with the RWA assembly 190 and the BAT power. With this configuration, instead of using a single regulator as in the conventional structure, additional regulator may be not directly connected with the line or terminal for the IGN signal or be configured to be operable regardless of the IGN signal, and be directly connected to the BAT power so that the motor position sensor can operate stably even when the BAT voltage range is high.

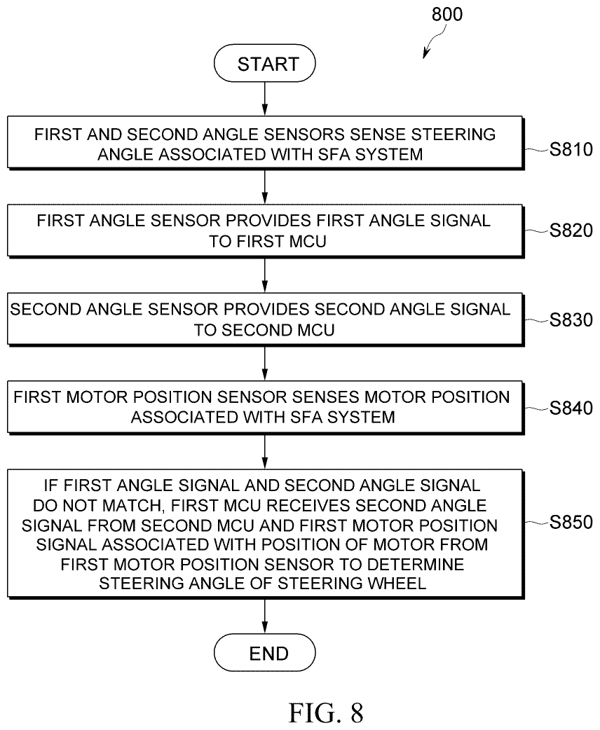

FIG. 8 is a flowchart showing a fail-safe method 800 for angle sensors in an SbW system according to an embodiment of the present disclosure. The fail-safe method 800 for the angle sensors in the SbW system may be performed by at least one sensor and/or control device or controller of the SbW system. The fail-safe method 800 for the angle sensors in the SbW system may be started by a first angle sensor configured to sense a steering angle of a steering wheel associated with an SFA assembly (step S810). Moreover, a second angle sensor may also sense the steering angle of the steering wheel associated with the SFA assembly (step S810).

According to an embodiment of the present disclosure, the first angle sensor may provide a first angle signal corresponding to the steering angle of the steering wheel to a first MCU (step S820). Moreover, the second angle sensor may provide a second angle signal corresponding to the steering angle of the steering wheel to a second MCU (step S830). Furthermore, the first motor position sensor may sense a motor position associated with the SFA assembly (step S840).

At least two steps of S810 to S840 may be performed simultaneously or at the same time.

If the first angle signal and the second angle signal do not match each other, the first MCU may receive the second angle signal from the second MCU and a first motor position signal associated with the position of the motor from the first motor position sensor to determine the steering angle of the steering wheel (step S850). Then, the first MCU may compare the first angle signal, the second angle signal, and the first motor position signal with each other to determine at least two signals matching each other as normal signals corresponding to the steering angle of the steering wheel.

According to an embodiment of the present disclosure, the first motor position sensor may have an initial median value of the steering wheel and generate a first motor position signal associated with the steering angle of the steering wheel based on the initial median value of the steering wheel and the sensed position of the motor. Moreover, the first motor position sensor may be separated from a line or terminal for the IGN signal and be configured to be operable regardless of the IGN signal, and be connected to the battery power, and thus the first motor position sensor can always remain in an ON state even when the vehicle ignition is in either an ON or OFF state.

Additionally or alternatively, the second MCU may receive the first angle signal from the first MCU and a second motor position signal associated with the position of the motor from a second motor position sensor to determine the steering angle of the steering wheel. For example, the second MCU may compare the first angle signal, the second angle signal, and the second motor position signal with each other to determine two signals matching each other as normal signals corresponding to the steering angle of the steering wheel.

According to an embodiment of the present disclosure, the second motor position sensor may have an initial median value of the steering wheel and generate a second motor position signal associated with the angle of the steering wheel based on the initial median value of the steering wheel and the sensed position of the motor. Moreover, the second motor position sensor may be separated from a line or terminal for the IGN signal and be configured to be operable regardless of the IGN signal, and be connected to the battery power, and thus the second motor position sensor can always remain in an ON state when the vehicle ignition is in either an ON or OFF state.

Additionally or alternatively, the fail-safe method 800 for the angle sensors in the SbW system can be started by a third angle sensor and a fourth angle sensor configured to sense the steering angle of the vehicle wheels associated with the RWA assembly. The third angle sensor may provide a third angle signal to a third MCU, and the fourth angle sensor may provide a fourth angle signal to a fourth MCU. And, a third motor position sensor may configure to sense a motor position associated with the RWA assembly.

If the third angle signal and the fourth angle signal do not match each other, the third MCU may receive the fourth angle signal from the fourth MCU and a third motor position signal associated with the position of the motor from the third motor position sensor to determine the steering angle of the vehicle wheels. For example, the third MCU may compare the third angle signal, the fourth angle signal, and the third motor position signal with each other to determine two signals matching each other as normal signals corresponding to the steering angle of the vehicle wheels.

According to an embodiment of the present disclosure, the third motor position sensor may have an initial median value of the vehicle wheels and generate a third motor position signal associated with the steering angle of the vehicle wheels based on the initial median value of the vehicle wheels and the sensed position of the motor. Moreover, the third motor position sensor may be separated from a line or terminal for the IGN signal and be configured to be operable regardless of the IGN signal, and be connected to the battery power and, thus the third motor position sensor can always remain in an ON state when the vehicle ignition is in either an ON or OFF state.

Additionally or alternatively, the fourth MCU may receive the third angle signal from the third MCU and a fourth motor position signal associated with the position of the motor from a fourth motor position sensor to determine the steering angle of the vehicle wheels. For example, the fourth MCU may compare the third angle signal, the fourth angle signal, and the fourth motor position signal with each other to determine two matching signals as normal signals corresponding to the steering angle of the vehicle wheels.

According to an embodiment of the present disclosure, the fourth motor position sensor may have an initial median value of the vehicle wheels and generate a fourth motor position signal associated with the angle of the steering wheel based on the initial median value of the vehicle wheels and the sensed position of the motor. Moreover, the fourth motor position sensor may be separated from a line or terminal for the IGN signal and be configured to be operable regardless of the IGN signal, and connected to the battery power, and thus the fourth motor position sensor can always remain in an ON state when the vehicle ignition is in either an ON or OFF state.

The above-described methods and/or various embodiments may be implemented in digital electronic circuitry, in computer hardware, firmware, software, or in combinations thereof. Various embodiments of the present disclosure may be executed by a data processing apparatus including, for example, one or more programmable processors and/or one or more computing devices, or may be implemented as a computer readable recording medium and/or a computer program stored on a computer readable recording medium. The above-described computer program can be written in any form of programming language, including compiled or interpreted languages, and it can be deployed in any form, including as a stand-alone program or as a module, component, subroutine, or another unit suitable for use in a computing environment. The computer program can be deployed to be executed on one computing device or on multiple computing devices at one site or distributed across multiple sites and interconnected by a communication network.

The above-described methods and/or various embodiments, for example, but limited to, the MCU, can be performed by one or more processors that are configured to execute one or more computer programs to perform operations, functions, etc. by operating on input data or by generating output data. For example, the methods and/or various embodiments of the present disclosure can also be performed by special purpose logic circuitry, e.g., a Field Programmable Gate Array (FPGA) or an Application Specific Integrated Circuit (ASIC), and an apparatus and/or system for performing the methods and/or embodiments of the present disclosure can be implemented as special purpose logic circuitry such as FPGA or ASIC.

One or more processors for executing a computer program may include both general and special purpose microprocessors and/or one or more processors of any kind of digital computing device. The processor may receive instructions and/or data from a read only memory or a random access memory or both. Components of a computing device, for example, but limited to, the MCU, for performing the methods and/or some embodiments of the present disclosure may include one or more processors for performing instructions and one or more memory devices for storing instructions and/or data.

According to an embodiment of the present disclosure, the computing device can receive data from or transfer data to, or both, one or more mass storage devices for storing data. For example, the computing device can receive data from a magnetic disc or optical disc and/or transfer data to the magnetic disc or optical disc. Computer readable media suitable for storing computer program instructions and/or data associated with a computer program may include all forms of non-volatile memory, including semiconductor memory devices, such as Erasable Programmable Read-Only Memories (EPROMs), Electrically Erasable Programmable Read-Only Memories (EEPROMs), and flash memory devices, but are not limited thereto. For example, the computer readable storage media may include magnetic discs such as internal hard discs or removable discs, magneto-optical discs, and CD-ROM and DVD-ROM discs.

To provide interaction with a user, the computing device may include a display device (e.g., cathode ray tube (CRT), liquid crystal display (LCD), etc.) for providing the user with information or a pointing device (e.g., keyboard, mouse, trackball, etc.) for allowing the user to provide input and/or commands on the computing device, but is not limited thereto. That is, the computing device may further include other types of devices for providing interaction with the user. For example, for interaction with the user, the computing device may provide the user with any form of sensory feedback, including visual feedback, auditory feedback, and/or tactile feedback. In this regard, the user may provide input to the computing device through various gestures such as a visual, a voice, and a motion.

In the present disclosure, various embodiments may be implemented in a computing system that includes a back-end component (e.g., a data server), a middleware component (e.g., an application server), and/or a front-end component. In this case, the components can be interconnected by any form or medium of digital data communication, such as a communication network. For example, the communication network may include a local area network (LAN), a wide area network (WAN), and the like.

The computing device based on certain exemplary embodiments described in the present disclosure can be implemented using hardware and/or software configured to interact with a user, including a user device, user interface (UI) device, user terminal, or client device. For example, the computing device may include a portable computing device such as a laptop computer. Additionally or alternatively, the computing device may include personal digital assistants (PDAs), tablet PCs, game consoles, wearable devices, internet of things (IoT) devices, virtual reality (VR) devices, augmented reality (AR) devices, etc., but is not limited thereto. The computing device may further include other types of devices configured to interact with a user. Further, the computing device may include a portable communication device (e.g., a mobile phone, smart phone, wireless cellular phone, etc.) suitable for wireless communication over a network, such as a mobile communication network. The computing device may be configured to communicate wirelessly with a network server using wireless communication technologies and/or protocols such as radio frequency (RF), microwave frequency (MWF), and/or infrared ray frequency (IRF).

Various embodiments disclosed herein, including specific structural and functional details, are exemplary. Therefore, embodiments of the present disclosure are not limited to those described above and may be implemented in various other forms. Moreover, the terms used herein are intended to describe specific embodiments and are not construed as limiting the embodiments. For example, the singular forms may be construed to include the plural forms as well, unless the context clearly dictates otherwise.

Unless otherwise defined herein, all terms used herein including technical or scientific terms have the same meanings as those generally understood by those skilled in the art to which the present disclosure pertains. It will be further understood that terms defined in dictionaries that are commonly used should be interpreted as having meanings that are consistent with their meanings in the context of the relevant art.

While the present disclosure has been described with reference to certain embodiments, it will be understood by those skilled in the art that various modifications and changes may be made without departing from the spirit and scope of the present disclosure as defined by the appended claims. Moreover, all such modifications and changes should be considered to be within the scope of the appended claims.

What is claimed is:

1. A system for a fail-safe operation for angle sensors in a Steer-by-Wire (SbW) system, the system comprising:
first and second angle sensors configured to sense a steering angle of a steering wheel associated with a steering feedback actuator assembly;
a first micro control unit (MCU) configured to receive a first angle signal corresponding to the steering angle of the steering wheel sensed by the first angle sensor;
a second MCU configured to receive a second angle signal corresponding to the steering angle of the steering wheel sensed by the second angle sensor; and
a motor position sensor configured to sense a position of a motor associated with the steering feedback actuator assembly,
wherein the first MCU is configured to, if the first angle signal corresponding to the steering angle of the steering wheel sensed by the first angle sensor and the second angle signal corresponding to the steering angle of the steering wheel sensed by the second angle sensor do not match each other, receive a motor position signal associated with the position of the motor from the motor position sensor to determine the steering angle of the steering wheel for controlling the SbW system.

2. The system of claim 1, wherein the first MCU is configured to compare the first angle signal corresponding to the steering angle of the steering wheel sensed by the first angle sensor, the second angle signal corresponding to the steering angle of the steering wheel sensed by the second sensor, and the motor position signal associated with the position of the motor sensed by the motor position sensor with each other to determine two signals matching each other among the first angle signal, the second angle signal, and the motor position signal as normal signals corresponding to the steering angle of the steering wheel.

3. The system of claim 1, wherein the motor position sensor has an initial median value of the steering wheel.

4. The system of claim 3, wherein the motor position signal associated with the position of the motor is generated to be corresponded to the steering angle of the steering wheel based on the initial median value of the steering wheel and the position of the motor sensed by the motor position sensor.

5. The system of claim 1, wherein the motor position sensor is not connected to a line or terminal for an ignition signal and is connected to a battery power.

6. The system of claim 5, further comprising a regulator connected between the battery power and the motor position sensor and configured to convert a voltage of the battery power into a voltage for being supplied to the motor position sensor.

7. The system of claim 1, wherein the motor position sensor is configured to be in an ON state even when a vehicle ignition is in an OFF state.

8. The system of claim 1, further comprising an other motor position sensor configured to sense the position of the motor associated with the steering feedback actuator assembly, wherein the second MCU configured to:
receive the first angle signal corresponding to the steering angle of the steering wheel sensed by the first angle sensor from the first MCU, and
receive an other motor position signal associated with the position of the motor from the other motor position sensor to determine the steering angle of the steering wheel for controlling the SbW system.

9. The system of claim 8, wherein the second MCU is configured to compare the first angle signal corresponding to the steering angle of the steering wheel sensed by the first angle sensor, the second angle signal corresponding to the steering angle of the steering wheel sensed by the second angle sensor, and the other motor position signal associated with the position of the motor sensed by the other motor position sensor with each other to determine two signals matching each other among the first angle signal, the second angle signal and the other motor position signal as normal signals corresponding to the steering angle of the steering wheel.

10. The system of claim 8, wherein the other motor position sensor has an initial median value of the steering wheel.

11. The system of claim 10, wherein the other motor position signal associated with the position of the motor is generated to be corresponded to the steering angle of the steering wheel based on the initial median value of the steering wheel and the position of the motor sensed by the other motor position sensor.

12. The system of claim 8, wherein the other motor position sensor is not connected to a line or terminal for an ignition signal and is connected to a battery power.

13. The system of claim 12, further comprising a regulator connected between the battery power and the other motor position sensor and configured to convert a voltage of the battery power into a voltage for being supplied to the other motor position sensor.

14. The system of claim 8, wherein the other motor position sensor is configured to be in an ON state even when a vehicle ignition is in an OFF state.

15. A module for an SbW system, comprising:
at least one motor position sensor configured to sense a position of a motor, wherein the motor position sensor is not connected to a line or terminal of an ignition signal and is connected to a battery power;
at least one MCU connected to the line or terminal for the ignition signal and the battery power; and
a regulator configured to convert a voltage of the battery power into a voltage for being supplied to the at least one MCU.

16. The module for the SbW system of claim 15, wherein the at least one motor position sensor has an initial median value of a steering wheel.

17. The module for the SbW system of claim 15, wherein the at least one motor position sensor is configured to generate a motor position signal associated with a steering angle of a steering wheel based on an initial median value of a steering wheel and the position of the motor sensed by the at least one motor position sensor.

18. The module for the SbW system of claim 15, further comprising an other regulator configured to convert the voltage of the battery power into a voltage for being supplied to the at least one motor position sensor.

19. The module for the SbW system of claim 15, wherein the at least one MCU is configured to determine a steering angle of a steering wheel based on a first angle signal of a first angle sensor, a second angle signal of a second angle sensor, and a motor position signal of the at least one motor position sensor.

20. A fail-safe method for angle sensors in an SbW system, the method performed by at least one processor and comprising:
sensing, by first and second angle sensors, a steering angle of a steering wheel associated with a steering feedback actuator assembly;
providing, by the first angel sensor, a first angle signal corresponding to the steering angle of the steering wheel sensed by the first angle sensor to a first MCU;
providing, by the second angel sensor, a second angle signal corresponding to the steering angle of the steering wheel sensed by the second angle sensor to a second MCU;
sensing, by a motor position sensor, a position of a motor associated with the steering feedback actuator assembly; and
if the first angle signal corresponding to the steering angle of the steering wheel sensed by the first angle sensor and the second angle signal corresponding to the steering angle of the steering wheel sensed by the second angle sensor do not match each other, receiving, by the first MCU, a motor position signal associated with the position of the motor from the motor position sensor to determine the steering angle of the steering wheel for controlling the SbW system.
